(19) United States
(12) Patent Application Publication
(10) Pub. No.: US 2015/0079408 A1
(43) Pub. Date: Mar. 19, 2015

(54) MODIFIED PORCELAIN VENEER FOR BONDING TO BIOCERAMICS

(71) Applicant: RESEARCH TRIANGLE INSTITUTE, Research Triangle Park, NC (US)

(72) Inventors: Jeffrey Robert Piascik, Raleigh, NC (US); Brian R. Stoner, Chapel Hill, NC (US)

(21) Appl. No.: 14/395,230

(22) PCT Filed: Apr. 18, 2013
(86) PCT No.: PCT/US2013/037103

§ 371 Date: Oct. 17, 2014

Related U.S. Application Data
(60) Provisional application No. 61/635,475, filed on Apr. 19, 2012.

(51) Int. Cl. A61C 13/083; A61C 5/10; A61C 13/08; A61C 5/08; A61C 8/00

(52) U.S. Cl. CPC A61C 13/083; A61C 5/08; A61C 8/005; A61C 13/082; A61C 5/10
USPC 428/432; 428/454; 433/202.1; 433/218; 433/201.1; 427/2.27

(57) ABSTRACT

A fluorine-containing porcelain, such as a porcelain material comprising a fluorine-doped glass, is provided for use in dental applications. The porcelain may be used to overlie at least a portion of a dental component such that an interface between the porcelain and the dental component comprises a fluorinated metal oxide. Methods for producing such fluorine-containing porcelains and for treating dental components with such fluorine-containing porcelains are also provided. The fluorine-containing porcelain may exhibit enhanced bonding to the underlying dental component such as a high strength ceramic.

### FIELD OF THE INVENTION

The invention is related to methods for enhanced bonding of dental restorations. It is also related to dental restorations wherein one or more materials are functionalized to afford reactivity with various other materials.

### BACKGROUND OF THE INVENTION

Prosthetic dental restorations can be direct restorations or indirect restorations. Direct restorations are often known as “fillings,” and require a soft material to be applied to a cavity located in a tooth. The soft material is subsequently cured to give a restored tooth structure. Indirect restorations are generally fabricated before being used within the mouth, and then the finished restoration is bonded to an appropriate structure within the mouth (e.g., existing tooth structure, bone, synthetic implant abutment, etc.). Exemplary indirect restorations include, but are not limited to, bridges, crows, inlays, onlays, and veneers, etc. The chemical makeup of such indirect restorations can vary.

Restorations comprising a porcelain veneer layered on a core material are often used, particularly where aesthetics are a concern (e.g., to address concerns with the front teeth). Porcelain is a white, translucent ceramic that is applied and fired to a glazed state. Generally, dental labs first construct a core. Subsequently, layers of porcelain are applied to an outer surface of the core, which can then be heated to sinter/solidify the porcelain and create a physical “fit” on the core. Porcelain veneers are advantageous in their ability to mimic the look of natural tooth by the application of multiple layers of varying translucency. Various materials can serve as the core material for such a veneer, including, but not limited to, natural tooth, metal, and/or ceramics. Good adhesion is important in such applications for high retention, prevention of microleakage, and fracture and fatigue resistance. In order to ensure good adhesion between a porcelain veneer and a core material, various methods have been utilized, including, but not limited to, particle abrasion, acid etching, application of bonding agents, and silanation of the core surface.

High strength ceramics such as alumina and zirconia-based ceramics can be particularly advantageous as core materials, as they may provide better fracture resistance and long-term durability than traditional dental materials. However, high strength ceramics generally cannot be attached/bonded using conventional cementation/attachment techniques used for other dental materials. Thus, all-ceramic restorations comprising high strength ceramics generally suffer from failure, as the components are not readily bonded to one another. See, for example, Sailer et al., Clin. Oral Implants Res. 2007 June; 18 Suppl. 3: 86-96 and Guazzato et al., Int. J. Prosthodont. 2004 March-April; 17(2): 142-139 and Choi et al., J Adv. Prosthodont. 2009 November; 1(3): 129-135, which are incorporated herein by reference. Several failure modes have been shown for restorations comprising high strength ceramic cores and porcelain coating veneers. For example, adhesive/cohesive failure has been observed, where there is a loss of adhesion between the ceramic core and the underlying structure (e.g., tooth). Chipping has been observed, which results from a loss of adhesion at the core/veneer interface, created from a mismatch between the coefficients of thermal expansion of the two materials and indicating no chemical bonding between the high strength ceramic core and the porcelain veneer. Veneer failure has also been shown, where cracking is initiated within the porcelain, created from firing and from a mismatch between the coefficients of thermal expansion of the two materials.

Certain methods have been developed for providing enhanced reactivity of high strength ceramic surfaces. See, for example, Aboushelib M N, Matinlinna J P, Salameh Z, Ounsi H., Innovations in Bonding Zirconia-Based Materials: Part I. Dent. Mat. 2008; 24: 1268-1272, U.S. application Ser. No. 13/273,528, filed Oct. 14, 2011 to Piascik et al.; and International

Application No. PCT/US2011/57055 to Piascik et al., which are incorporated herein by reference. However, in such embodiments, each core must be individually treated to enhance the bonding capabilities thereof.

It would be advantageous to provide a means by which a high strength ceramic and a porcelain material could be more strongly adhered together to ensure that the resulting structures are durable in use for a significant period of time.

### BRIEF SUMMARY OF THE INVENTION

In one aspect of the present invention is provided a modified dental porcelain material that is capable of reacting directly with various underlying materials (e.g., including, but not limited to, high-strength ceramic materials). In certain embodiments, preparation and use of such modified dental porcelain materials are readily compatible with existing ceramic lab and dental processes and protocols. For example, certain modified dental porcelain materials provided herein can be readily prepared by mixing and applied to other dental components using traditional techniques.

In certain aspects, a dental structure comprising a porcelain layer overlying at least a portion of a second dental component is provided, wherein the interface between the porcelain layer and the second dental component comprises a fluorinated metal oxide. The fluorinated metal oxide interface can be provided, for example, via plasma treatment of the second dental component or by modification of a porcelain material, as described herein in greater detail. The makeup of the second dental component can, in certain embodiments, be selected from the group consisting of zirconia, alumina, titania, chromium oxide, or a combination thereof. In certain embodiments, the second dental component comprises an yttria-stabilized ceramic. The interface can, in such embodiments, further comprise YF₃. In certain embodiments, the second dental component can comprise a fluorine-modified surface. In some embodiments, such a fluorine-modified surface may comprises a plasma-pretreated surface.

In some embodiments, the porcelain layer of the dental structure comprises one or more fluorine-doped glasses. The fluorine-doped glasses can be, in some embodiments, be selected from the group consisting of fluorosilicate glasses, oxide glasses doped with metal fluorides (e.g., zirconium fluoride and/or yttrium fluoride), fluorophosphate glasses, fluorozirconate glasses, fluoroaluminate glasses, calcium aluminofluorosilicate glasses, alkaline earth metal aluminofluorosilicate glasses, and combinations thereof The dental structure can, in some embodiments, comprise a crown, bridge, veneer, inlay, or onlay. In certain embodiments, the ceramic component comprises an abutment.

In certain aspects of the present invention are provided methods for preparing a dental structure with enhanced bonding, comprising applying a porcelain powder comprising fluorine-doped glass powder to a dental component and firing to give a dental structure comprising a porcelain layer overlying the dental component, wherein the interface between the porcelain layer and the dental component comprises a fluorinated metal oxide. The applying step may, in some embodiments, comprise mixing one or more porcelain powders with a solvent to give a slurry and contacting a surface of the dental component with the slurry by brushing, spatulation, spraying, dipping, whipping, vibrating, and/or electrodepositing the slurry thereon. The firing can, in some embodiments, be conducted for a time and at a temperature sufficient to sinter the modified porcelain powder. In some embodiments, the dental component comprises a fluorine-modified surface prior to said applying and firing steps. The fluorine modified surface can, for example, comprise a plasma-pretreated surface.

### BRIEF DESCRIPTION OF THE DRAWING

Having thus described the invention in general terms, reference will now be made to the accompanying drawing, which is not necessarily drawn to scale, and wherein:

FIG. 1 is a depiction of an exemplary dental structure of the present invention.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout. As used in the specification, and in the appended claims, the singular forms “a”, “an”, “the”, include plural referents unless the context clearly dictates otherwise.

One aspect of the invention relates to methods of preparing the surface of a dental restoration for further functionalization and/or attachment. In certain embodiments, the method relates to preparing a porcelain surface by incorporating a fluorine-containing glass component therein. Preparing a porcelain material in this way allows for chemical bonding between the porcelain and various other materials, including, but not limited to, high strength ceramics (e.g., alumina and zirconia-based ceramics). Another aspect of the invention provides a dental restoration comprising porcelain and an underlying structure, wherein the porcelain is attached to the underlying structure by means of a layer comprising fluorine-containing glass. Advantageously, the porcelain may be covalently bonded to the underlying structure in this way.

### I. Definitions

“Dental implant” as used herein means a post (i.e., a dental abutment) anchored to the jawbone and topped with individual replacement teeth or a bridge that is attached to the post or posts. The term is meant to encompass traditional dental implants as well as mini-dental implants. In some cases where the dental abutment is in the form of natural tooth, the dental implant only comprises the implanted replacement tooth or bridge.

“Restorative” or “restoration” as used herein means any dental component used to restore the function, integrity and/or morphology of any missing tooth structure. Examples of restoratives that may be provided according to the methods described herein include, but are not limited to, crowns, bridges, fillings, veneers, inlays and onlays, as well as endodontic devices including endodontic cones and devices for endodontic root perforation repair.

“Orthodontic device” as used herein means any device intended to prevent and/or correct irregularities of the teeth, particularly spacing of the teeth. Orthodontic devices particularly relevant to the present invention include but are not limited to orthodontic brackets.

“Dental component” as used herein encompasses any component of a dental implant or a restorative or an orthodontic device and can even include, in certain embodiments, natural tooth.

“Porcelain” as used herein generally refers to dental porcelain, also known as dental ceramic. The chemical composition of such porcelains is widely variable and they may comprise such components as clay (in the form of kaolin/kaolinate), glass, quartz, feldspar, bone ash, steatite, petuntse, and alabaster. Dental porcelains can, in some embodiments, contain single metal oxides or various mixtures of metal oxides (e.g., silica, aluminum oxide, calcium oxide, potassium oxide, titanium dioxide, zirconium oxide, tin dioxide, rubidium dioxide, barium oxide, boric oxide, and/or other oxides). Another exemplary component of a dental porcelain in some embodiments is leucite (crystals of a potash-alumina-silica complex). Various materials can be included within a porcelain, for such purposes as enhanced strength. Other exemplary porcelain materials are described, for example, in EP Patent Publication EP 0272745, which is incorporated herein by reference in its entirety.

### II. Modified Porcelains

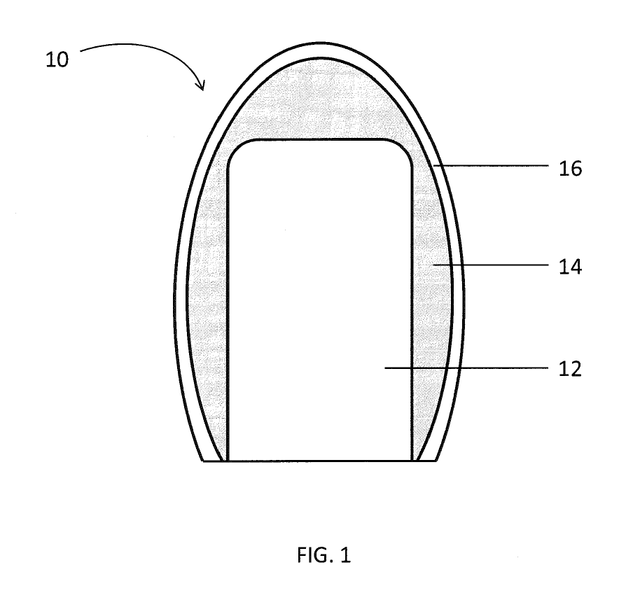

According to certain aspects of the invention, a method to modify the interaction between two dental components (e.g., a porcelain-based dental component (e.g., a restoration) and a second dental component) is provided. In some embodiments, the interaction comprises chemical bonding between the surface of the porcelain-based dental component and the second dental component. For example, in certain specific embodiments, the porcelain-based dental component comprises a veneer and the second dental component is a ceramic core (e.g., an abutment). This type of dental structure 10 is illustrated in FIG. 1, wherein a tooth structure 12 is modified with a ceramic abutment 14 and the abutment is coated with a porcelain veneer layer 16. However, the components can comprise any types of dental components, restoratives, or orthodontic devices as described above. Various means are known for preparing and shaping second dental components. For example, in certain embodiments, computer-aided design and computer-aided manufacturing (CAD/CAM) techniques are used as understood and commonly used in the dental field.

The second dental component advantageously comprises a high-strength ceramic (e.g., a zirconia, alumina, titania, or chromium-oxide-based material which may be unstabilized (i.e., pure) or may comprise a stabilized material, e.g., a fully or partially stabilized ceramic material). For example, in specific embodiments, the ceramic may be stabilized with an oxide (e.g., yttrium oxide, magnesium oxide, calcium oxide, and/or cerium(III) oxide). In certain specific embodiments, the second dental component comprises yttria-stabilized zirconia (YSZ). The composition of the second dental component is not limited to high-strength ceramics, although the invention is described herein in relation to high strength ceramic components. Other types of materials that may comprise a dental component to which a porcelain-based dental component can be attached are also intended to be encompassed herein.

It has been shown that a high strength ceramic core (zirconia) in combination with a porcelain veneer exhibits significantly decreased shear bond strengths (with mixed cohesive and adhesive failures) as compared with a metal core in combination with a porcelain veneer. See, e.g., J. Adv. Prosthodont. (2009) 1: 129-135, which is incorporated herein by reference. Although not intended to be bound by theory, it is believed that these failures may arise because there is generally no chemical interaction (e.g., bonding) between a high strength ceramic and a porcelain material.

The present invention provides for enhanced interaction (e.g., via chemical bonding) between two dental components, such as between a high strength ceramic core and a porcelain veneer. The porcelain and second dental component are advantageously chemically bonded, at least in part, directly to one another. The type of bonding (e.g., covalent, ionic, hydrogen, and mixtures thereof) may vary and is not intended to be limiting of the invention. In some embodiments, a fluorine-containing interfacial layer is formed between two such materials. Although not intended to be limiting, it is believed that this interfacial layer may comprise a fluorinated metal oxide.

Bonding between a porcelain and a second dental component can be provided, for example, by treating the second dental component to provide a fluorine-modified surface, which can be subsequently attached to the porcelain-based dental component. For example, the second dental component may be treated by plasma fluorination such as described in Piascik et al., Dental Mater. (2009) 25: 1116-1121; Piascik et al., Dental Mater. (2011) 27(5): e99-e105; Piascik et al., J. Biomed. Mater. Res. B: Applied Biomater. (2011) 98B(1): 114-119; Wolter et al., Applied Surface Sci. (2011) 257(23): 10177-10182; and PCT/US2011/57055 to Piascik et al., which are incorporated herein by reference. The resulting treated dental component can be coated with a porcelain and fired to give a porcelain overlying a second dental component.

Alternatively or additionally, the porcelain-based dental component can be tailored prior to application to the second dental component, to incorporate fluorine atoms and/or ions therein, such that the porcelain comprises fluorine which can aid in bonding the porcelain to a second dental component. Again, this bonding can be provided by means of a fluorine-containing interfacial layer between the porcelain-based dental component and the second dental component. Thus, by formation of a fluorine-containing surface on the porcelain-based dental component, it may, in certain embodiments, be unnecessary to treat the second dental component to ensure sufficient adhesion between the dental components. The methods by which the porcelain-based dental component can be modified may, in certain embodiments, be readily implemented by slight modifications to existing protocols for all-ceramic restoration placement.

In certain embodiments, the method of the invention generally comprises modifying a porcelain-based dental component to provide a fluorine-containing surface. Generally, porcelain materials are prepared by first blending the porcelain components (e.g., ceramic precursors such as silica, alumina, feldspar, calcium carbonate, sodium carbonate, potassium carbonate, and other components as described above). Advantageously, the components are blended in finely divided powder form. The resulting mixture is heated and fused at an elevated temperature (e.g., at least about 1200° C.) to form a glass (also known as &frit). The molten glass is quenched, dried, and ground to provide the porcelain material in the form of a powder. The porcelain powder may further comprise various additional components including, but not limited to, binders, pigments, and/or opacifiers, which can be added along with the ceramic precursors or can be combined with the porcelain powder.

Variations in the chemical makeup of the porcelain powder can impact the physical properties of the ceramic precursor mixture and thus may dictate the methods that are used to use the ceramic powder. For example, certain ceramic powders may require different temperatures to fuse the particles following application to a substrate. Porcelains can be characterized as “high-fusing ceramics” (generally having a fusion temperature of from about 1288° C. to about 1371° C.), “medium-fusing ceramics” (generally having a fusion temperature of from about 1093° C. to about 1260° C., or “low fusing ceramics” (generally having a fusion temperature of from about 660° C. to about 1066° C.).

Various porcelain powders are commercially available, including, but not limited to, IPS Empress® layering materials and IPS e.max® Ceram (Ivoclar Vivadent, Amherst, N.Y.); Ceramco® porcelains (Dentsply Prosthetics, York, Pa.); Noritake Super Porcelain EX-3, TI-22, Cerabien, or Cerabien ZR (Noritake Dental Supply Co., Ltd., Japan); OPC® Low Wear™ (Jeneric/Pentron Inc., Wallingford, Conn.); Vita Titanium Porcelain, VMK, VM®7, VM®9, and VM®13 porcelains (Vident, Brea, Calif.); Pulse, Creation, and Authentic Powders (Jensen Dental, North Haven, Conn.); CeraMax (AlphaDent Co., Ltd., Korea); C-Mix Fine Grain Porcelain (Arro Rosenson, Inc., Mineola, N.Y.); Duceram, Duceragold™, Cercon Ceram, and Allceram veneering ceramics (DeguDent GmbH, Germany); ISIS™ porcelain (Provident Dental Products, Somerset, N.J.); and Synspar® and Avante® porcelains (Pentron® Ceramics, Inc., Somerset, N.J.). Other exemplary porcelains and methods for their production are described, for example, in U.S. Pat. No. 4,645,454 to Amdur et al.; U.S. Pat. No. 4,741,699 to Kosmos et al.; U.S. Pat. No. 5,281,563 to Komma et al.; U.S. Pat. No. 5,453,290 to Van der Zel; U.S. Pat. No. 5,944,884 to Panzera et al.; and U.S. Pat. No. 6,428,614 to Brodkin et al.; and U.S. Patent Application Publication Nos. 2007/0196788 and 2009/0298016 to Chu et al., which are all incorporated herein by reference.

According to the invention, one or more such porcelain powders are mixed with a fluorine-containing glass material to provide a fluorinated porcelain powder. The fluorine-containing glass material can be added as a porcelain component along with the other components of the porcelain, such that all components are heated, fused together, cooled, and ground to give a fluorine-containing porcelain powder or the fluorine-containing glass material can be added as an additional component following formation of the porcelain powder. “Fluorine-containing glass;” “fluoroglass;” or “fluorine-doped glass” as used interchangeably herein, can encompass various glass-based materials containing varying levels of fluorine. Fluorine-containing glasses are generally provided in powdered form. For example, fluorine-containing glass can comprise a fluorosilicate glass. In other embodiments, the fluorine-containing glass can comprise an oxide glass doped with a metal fluoride (e.g., including, but not limited to, zirconium fluoride or yttrium fluoride), a fluorophosphate glass (i.e., a mixture of fluoride glass and phosphate glass), a fluorozirconate glass, a fluoroaluminate glass, a calcium aluminofluorosilicate glass, and alkaline earth metal aluminofluorosilicate glasses. Other exemplary fluorine-containing glass compositions are provided, for example, in U.S. Pat. No. 4,376,835 to Schmitt et al.; U.S. Pat. No. 4,717,691 to Lucas et al.; and U.S. Pat. No. 6,107,229 to Lück et al., which are incorporated herein by reference. The amount of fluorine-containing glass added to the porcelain can vary widely, e.g., between about 1% and about 10% by weight based on the porcelain powder (comprising the fluorine-containing glass component and the remaining porcelain components).

Generally, porcelain-based dental materials are prepared by providing one or more porcelain powders and mixing the one or more porcelain powders prior to application with a solvent (e.g., distilled water or an inorganic or organic liquid, such as an alkyl polyhydric alcohol, aryl alcohol, diaryl ether, or a derivative or combination thereof thereof; and/or methacrylate monomers) to give a slurry. The consistency of the slurry can vary, and may be, for example, in the form of a paste. Various other additives can be included within the slurry, for example, to adjust the consistency or drying process (e.g., working time) of the slurry. For example, glycerine, propylene glycol, and/or alcohols are common additives. The resulting slurry can then be applied to the surface of a second dental component (e.g., a core) in various ways. For example, it may be applied by brushing, spatulation, spraying, dipping, whipping, vibrating, and/or electrodeposition onto the second dental component. The coated second dental component is then fired to sinter the porcelain coating, which generally removes the solvent as well. The temperature required for sintering can vary; as noted above, the fusion temperatures of different porcelain compositions can vary widely. Generally, with commercially available porcelain powders, the manufacturer provides guidance on the necessary time and temperature for sufficient sintering. According to the present invention, it may be necessary to adjust these parameters to account for the presence of the fluorine-containing glass, and these adjustments would be well within the abilities of one of ordinary skill in the art.

In some embodiments, use of certain types of solvents and/or additives in the slurry can facilitate the preparation of the porcelain layers. For example, the solvent can comprise a polymerizable resin (i.e., comprising monomers) that is self-curing or light-cured. Following application of the porcelain slurry to the second dental component, the polymerizable resin can be cured to fix the porcelain coating in place in the desired shape and thickness. The dental structure can then be fired, which results in removal of the cured resin and sintering of the porcelain coating.

The thickness of each layer can vary. Further, multiple layers of porcelain slurry are generally applied to the second dental component to give a multilayered dental structure. The multiple porcelain layers may be the same or different. For example, for some applications, layers of varying translucencies and/or colors can be applied so as to produce a prosthetic or veneer that closely resembles actual tooth. In some embodiments, the general composition of the porcelain is comparable in the multiple layers, with slight variations in the amount of pigment and/or opacifying material. According to the invention, some layers may comprise fluorine-containing glass, whereas others may not comprise fluorine-containing glass. Advantageously, the first layer of a porcelain coated onto and adjacent to the second dental component comprises fluorine-containing glass. The optional one or more additional layers coated over the first layer of porcelain need not comprise fluorine-containing glass, although certain embodiments are provided wherein multiple layers may comprise fluorine-containing glasses.

Other porcelain-based dental materials are prepared by compacting one or more porcelain powders in solid form (“pressable” porcelains, or “press-to” ceramics). Exemplary commercially available pressable porcelain powders include, but are not limited to, Cergo® Kiss, Cercon® Ceram Press, Ducera® Press (DeguDent GmbH, Germany); IPS e.max Press and Empress® ceramics (Ivoclar Vivadent, Amherst, N.Y.); and Finesse® (Dentsply Prosthetics, York, Pa.). According to the invention, one or more pressable porcelain powders are mixed with a fluorine-containing glass material to provide a fluorinated pressable porcelain powder. The modified ceramic powder is subjected to pressure and heat, which converts the powder to a viscous state. The powder is pressed into the desired form and cooled. The powder can be cooled on a frame, such as on the second dental component of the present invention, to give a composite dental structure. For details on processing conditions and press ceramics, see, for example, EP 0231 773 and U.S. Patent Application Publication No. 2009/0011916 to Steidl, which are incorporated herein by reference.

Advantageously, fluorine-containing porcelains as described herein may be capable of forming a chemical bond with a second dental component (e.g., a high strength ceramic core). Although not intended to be limiting, it is believed that heating the composite dental structure (comprising a core and an overlying porcelain covering) to sinter the porcelain results in the formation of a fluorine-containing interfacial layer between the porcelain-based dental component and the second dental component. Although not intended to be bound by theory, it is believed that the fluorination processes of the invention result in fluorine replacing oxygen in the oxide lattice within the structure of the porcelain, thus creating a metastable, partially covalent, partially ionic bond capable of reacting with the surface of the second dental component.

The fluorine-containing interfacial layer may, in certain embodiments, comprise oxyfluorides and fluorosilicates. For example, where the second dental component comprises an yttria-stabilized zirconia (YSZ), it is believed that heating the composite dental structure may result in yttrium (Y) diffusion to the interfacial surface of the second dental component and fluoride (F) diffusion to the interfacial surface of the porcelain. It has been shown that a YSZ material subjected to F plasma treatment undergoes Y ion migration toward the surface of the material. See Piascik et al., Dental Mat. (2011) 27(5): e99-e105 and Piascik et al., J. Biomed. Mater. Res. B: Applied Biomat. (2011) 98B(1) 114-119, which are incorporated herein by reference. An interfacial layer thus may be formed, which allows for interaction of F from the porcelain and Y from the second dental component. Although not intended to be limiting, this interfacial layer may, in such embodiments, comprise an interfacial YF₃+ZrOₓF_{y} bonding layer.

The composite dental structures prepared according to the present invention generally may exhibit enhanced bonding between the porcelain and the second dental component. In some embodiments, they allow for the use of high-strength dental components (e.g., high strength ceramics), which may not require any type of physical or chemical treatment (e.g., micromechanical roughening, plasma treatment, and/or etching, etc.) in order to achieve chemical bonding with a porcelain coating. Advantageously, such composite dental structures may, in certain embodiments, exhibit lower incidences of failure. In particular, such composite dental structures are expected to exhibit significantly decreased incidences of chipping, which results from loss of adhesion at the interface of two materials (e.g., a porcelain layer and a second dental component).

That which is claimed:

1. A dental structure comprising a porcelain layer overlying at least a portion of a second dental component, wherein the interface between the porcelain layer and the second dental component comprises a fluorinated metal oxide.

2. The dental structure of claim 1, wherein the second dental component comprises a ceramic selected from the group consisting of zirconia, alumina, titania, chromium oxide, or a combination thereof.

3. The dental structure of claim 1, wherein the second dental component comprises a yttria-stabilized ceramic.

4. The dental structure of claim 3, wherein the interface further comprises YF₃.

5. The dental structure of claim 1, wherein the porcelain layer comprises one or more fluorine-doped glasses.

6. The dental structure of claim 5, wherein the one or more fluorine-doped glasses are selected from the group consisting of fluorosilicate glasses, oxide glasses doped with zirconium fluoride, oxide glasses doped with yttrium fluoride, fluorophosphate glasses, fluorozirconate glasses, fluoroaluminate glasses, calcium aluminofluorosilicate glasses, alkaline earth metal aluminofluorosilicate glasses, and combinations thereof.

7. The dental structure of claim 1, wherein the dental structure comprises a crown, bridge, veneer, inlay, or onlay.

8. The dental structure of claim 1, wherein the second dental component comprises an abutment.

9. The dental structure of claim 1, wherein the second dental component comprises a fluorine-modified surface.

10. The dental structure of claim 9, wherein the fluorine-modified surface comprises a plasma-pretreated surface.

11. A method for preparing a dental structure with enhanced bonding, comprising applying a porcelain powder comprising a fluorine-doped glass powder to a dental component and firing to give a dental structure comprising a porcelain layer overlying the dental component, wherein the interface between the porcelain layer and the dental component comprises a fluorinated metal oxide.

12. The method of claim 11, wherein the dental component comprises a ceramic selected form the group consisting of zirconia, alumina, titania, chromium oxide, or a combination thereof.

13. The method of claim 11, wherein the dental component comprises a yttria-stabilized ceramic.

14. The method of claim 13, wherein the interface further comprises YF₃.

15. The method of claim 11, wherein the fluorine-doped glass is selected from the group consisting of fluorosilicate glasses, oxide glasses doped with zirconium fluoride, oxide glasses doped with yttrium fluoride, fluorophosphate glasses, fluorozirconate glasses, fluoroaluminate glasses, calcium aluminofluorosilicate glasses, alkaline earth metal aluminofluorosilicate glasses, and combinations thereof.

16. The method of claim 11, wherein the dental structure comprises a crown, bridge, veneer, inlay, or onlay.

17. The method of claim 11, wherein the dental component comprises an abutment.

18. The method of claim 11, wherein the applying step comprises mixing the porcelain powder with a solvent to give a slurry and contacting a surface of the dental component with the slurry by brushing, spatulation, spraying, dipping, whipping, vibrating, and/or electrodepositing the slurry thereon.

19. The method of claim 11, wherein the firing is conducted for a time and at a temperature sufficient to sinter the porcelain powder.

20. The method of claim 11, wherein the dental component comprises a fluorine-modified surface prior to said applying and firing steps.

21. The method of claim 20, wherein the fluorine-modified surface comprises a plasma-pretreated surface.
